(19) United States
(12) Patent Application Publication
(10) Pub. No.: US 2001/0055544 A1
(43) Pub. Date: Dec. 27, 2001

(54) Probe arm with multiple detectors for locating disaster and accident victims

(76) Inventor: Douglas Copp, Alameda, CA (US)

Correspondence Address: Patrick D. Kelly, 11939 Manchester #403, St.Louis, MO, 63131, US

(21) Appl. No.: 09/803,231

(22) Filed: Mar. 9, 2001

Related U.S. Application Data
(63) Continuation-in-part of application No. 09/181,793, filed on Oct. 28, 1998, now abandoned.
(60) Provisional application No. 60/188,081, filed on Mar. 9, 2000.

(51) Int. Cl. G01N 27/00

(52) U.S. Cl. 422/98; 422/83; 73/23.24

(57) ABSTRACT

An electromechanical device is disclosed, referred to herein as a “detector arm”. It is useful for locating humans, either living or dead, who are trapped in a structure such as a building that collapsed or was badly damaged in an earthquake, mudslide, bombing, or other disaster. This device includes an extendible mechanical arm which is equipped with a gas inlet device, a miniature video lens and light source, and preferably at least one microphone, all mounted at or near the “distal” end or tip of the detector arm. Various wires, cables, and a gas inlet hose are tied to or otherwise supported by the detector arm, allowing the wires and hose to be coupled to supporting devices, such as a video display, audio amplifier, and multi-component gas detector. The supporting devices can be affixed to the handle of the detector arm, or they can be carried (along with a battery pack) in pouches or pockets in a harness, vest, or similar device worn by the person carrying the detector arm. The detector arm assembly is lightweight and portable, allowing a human operator to carry and maneuver it during a rescue or recovery operation inside a collapsed building or similar environment.

### RELATED APPLICATION

This application claims priority based on provisional application No. 60/188,081, filed Mar. 9, 2000, which in turn was designated as a continuation-in-part of utility application Ser. No. 09/181,793, filed Oct. 28, 1998.

### BACKGROUND OF THE INVENTION

This invention is in the field of electronic devices which can locate survivors and corpses in a building that has been damaged by an earthquake, mudslide, bombing, or other disaster. More particularly, it involves a lightweight extendable mechanical arm with a video lens and light source, a hose with an inlet for a gas detector, and other optional equipment, mounted at or near the tip of the detector arm.

The search for survivors and corpses after an earthquake, building collapse, bombing or terrorist attack, or other disaster, accident, crime, or similar event can be difficult, dangerous, and tedious. Searchers often must work under cramped, dark, difficult, high-risk conditions, knowing they might be killed if a damaged and unstable structure settles further. Survivors are often unconscious, badly injured, and unable to signal their location; and, since anyone trapped in a building that is collapsing will seek any available shelter, survivors and corpses are most often hidden under couches, tables, desks, or other collapsed furniture or structures, making it even more difficult for rescue or recovery teams to locate them.

The Applicant herein, Douglas Copp, is the Rescue Chief of the American Rescue Team International (ARTI). He has participated in hundreds of rescue and recovery operations, and has crawled into more than 800 collapsed or badly damaged buildings, mines, and other structures in the aftermaths of earthquakes, mudslides, cave-ins, and other disasters.

His work in rescuing survivors and recovering corpses under such conditions led to an invention which is already covered by a separate patent application, and which can be used as one part of this current invention. Briefly, his prior invention involves a combination of gas detectors which can detect at least three different volatile gases that are generated when bacteria decompose the flesh of dead humans. By proper selection of the three different gases (which can include, for example, methane, ammonia, and a volatile organic compound other than methane, such as ethylene or a ketone that is generated when livers decompose), a multi-unit gas detector which can detect each of those three gases at levels of 1 part per million (ppm) can identify probable locations of decomposing corpses, while eliminating the “false positive” readings that often occur when only one gas is being detected. That invention is described in further detail in U.S. patent application Ser. No. 09/181,793, the contents of which are incorporated herein by reference, and in PCT application PCT/US99/25343, also designated by WIPO number WO 00/25108. The contents of both of those patent applications are incorporated herein by reference.

During his testing and use of the gas detector system in several onshore post-disaster settings, Copp realized that an improved system with additional components and functions would make the system substantially more useful, not just in locating corpses, but in locating survivors as well.

Accordingly, one object of this invention is to disclose an improved device for helping rescue or recovery workers locate both survivors and corpses who are trapped in a damaged structure, such as a building which has collapsed or been damaged in an earthquake, mudslide, bombing, or other disaster.

Another object of this invention is to disclose a multifunctional detection device which can “see, hear, and smell” (i.e., which is provided with a miniaturized video lens, an audio microphone, and at least one gas detector), for use by rescue or recovery workers inside a damaged structure, such as a building which collapsed or was severely damaged by an earthquake, mudslide, bombing, or other disaster.

This and other objects of the invention will become more apparent through the following summary and description.

### SUMMARY OF THE INVENTION

An electromechanical device is disclosed, referred to herein as a “detector arm”. It is useful for locating humans, either living or dead, who are trapped in a structure such as a building that collapsed or was badly damaged in an earthquake, mudslide, bombing, or other disaster. This device includes an extendible mechanical arm which is equipped with a gas inlet device, a miniature video lens and light source, and preferably at least one microphone, all mounted at or near the “distal” end or tip of the detector arm. Various wires, cables, and a gas inlet hose are tied to or otherwise supported by the detector arm, allowing the wires and hose to be coupled to supporting devices, such as a video display, audio amplifier, and multi-component gas detector. The supporting devices can be affixed to the handle of the detector arm, or they can be carried (along with a battery pack) in pouches or pockets in a harness, vest, or similar device worn by the person carrying the detector arm. The detector arm assembly is lightweight and portable, allowing a human operator to carry and maneuver it during a rescue or recovery operation inside a collapsed building or similar environment.

### BRIEF DESCRIPTION OF THE DRAWING

FIG. 1 depicts an extendible pole, having a gas detector device and a video monitor attached to the handle segment, and with a gas detector hose and a wiring harness affixed to the pole segments, and with a miniature video lens, light source, directional microphone, and omnidirectional microphone affixed near the tip of the pole.

FIG. 2 depicts tip segment of an extendible pole, with a plurality of cylindrical fixation components, for detachably affixing a video lens, light source, and microphone to the tip segment.

### DESCRIPTION OF PREFERRED EMBODIMENTS

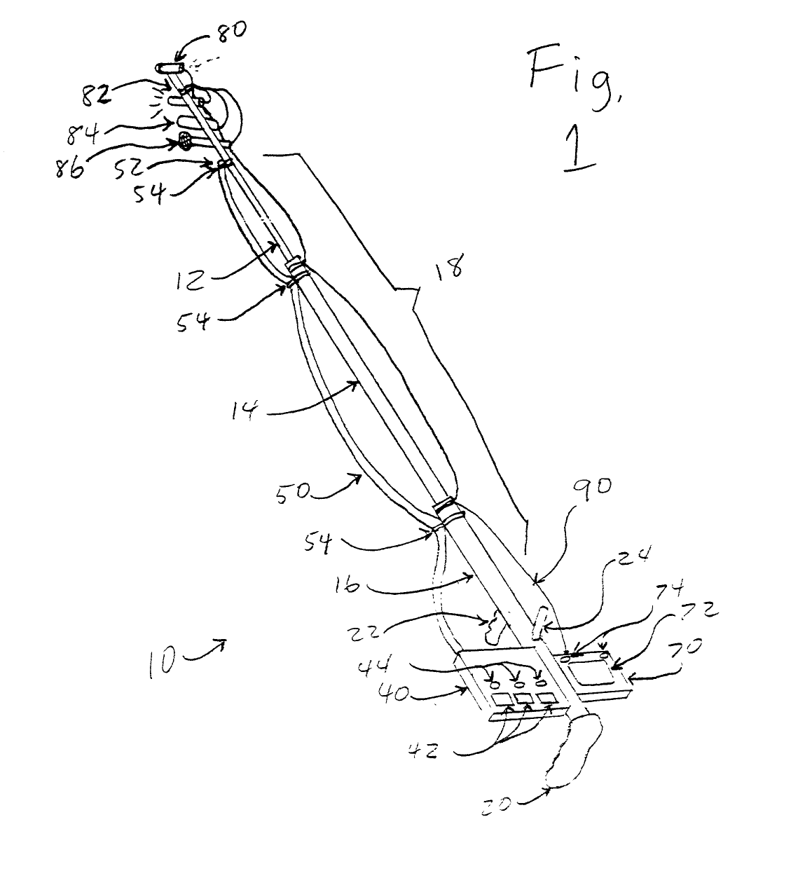

As summarized above, this invention discloses an extendable “detector arm” which is lightweight and mobile, and designed to be carried and used by a human operator (all references herein to “operator” refer to a person who is carrying the detector arm during a rescue or recovery operation). A preferred embodiment of such an assembly is shown as callout number 10, in FIG. 1.

The central structure of detector arm 10 comprises an extendible pole or rod 18, made of three “telescoping” segments, including “tip” segment 12, center segment 14, and handle segment 16. The distal end of tip segment 12 is referred to herein as the tip of pole 18; in FIG. 1, the miniaturized video lens 80 is mounted at the tip of tip segment 12.

All references to the “tip” of the arm include portions of the arm which are adjacent or close to the tip, even if they are sheltered and shielded by one or more protective or similar devices at the extreme tip of the arm. A protective device (such as a cowl or grid, made of metal or plastic) is preferred at the tip of the arm, to minimize the risk of damage to or fouling of electronic components or the gas hose inlet.

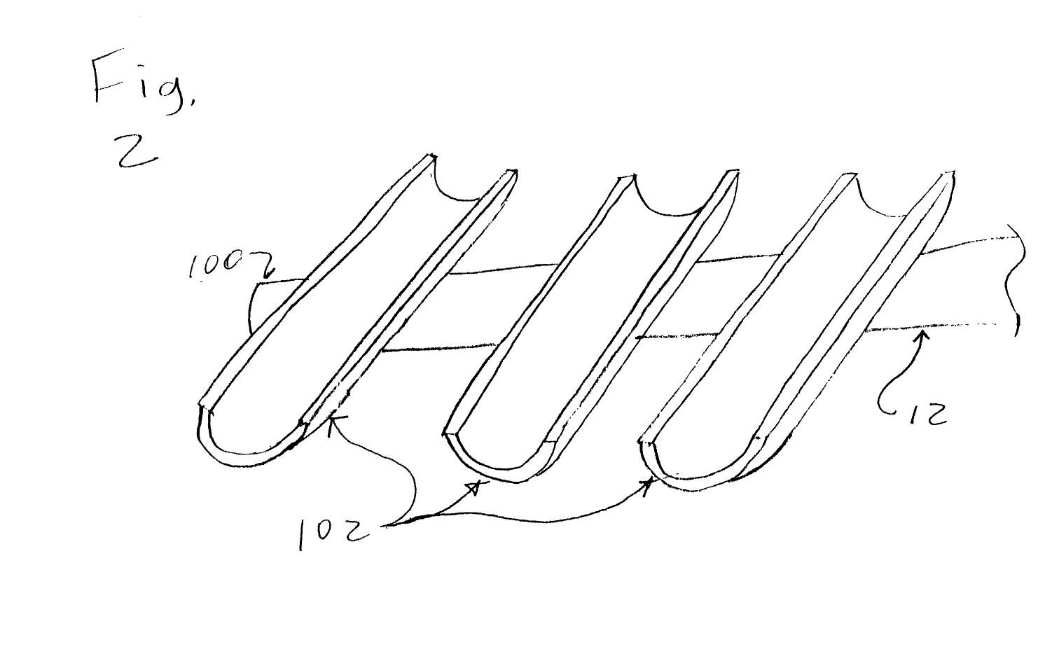

FIG. 2 depicts tip segment 100 of a pole segment 12, showing a plurality of cylindrical fixation components 102, welded to the pole segment 12 at a known and fixed angle. These channels will assist in detachably affixing a video lens, light source, and microphone to the tip segment, in a manner which establishes a clear directional orientation of the devices, duringuse, with respect to the handle component.

Handle segment 16 is coupled to handle 20. Additional handle components 22 and 24 can also be provided if desired, for convenience, to ensure that the orientation and direction of the video lens and microphone are known at all times, and to minimize fatigue in the operator. If desired, any or all of handle components 20-24 can be coupled to the shaft portion 16 in a detachable manner, so that they can be removed, if necessary, in order to extend the tip 12 of pole 18 as far as possible into a tight crevice or similar opening.

Unless otherwise clearly indicated, any references herein to “detector arm” (or “arm”) refer to the extendable arm (including all segments, joints, and other components which contribute to the supporting structure of the arm) and to any electrical components, wires, cables, hoses, or similar appurtenances which are coupled directly to the arm (such as by banding devices, belts, clamps, etc.) while the arm is in use. Additional devices (such as a video monitor, a gas detector, a battery pack, an audio amplifier, etc.) which have wires, cables, hoses, or similar components from the arm plugged in to them are not regarded as part of the arm; instead, they are referred to herein as “supporting devices”, since they will interact with the detector devices or light source mounted on the arm.

Two supporting devices, a gas detector 40 and a video display 70, are shown in FIG. 1 as being affixed to handle segment 16. Their location, near the handle and positioned in a balanced manner on opposite sides of handle segment 16, is designed to minimize weight and operator fatigue. In an alternate preferred embodiment, the gas hose 50 and wiring harness 90 are long enough to allow the gas detector 40 and/or video display 70 to be handled and carried apart from handle segment 16, so it or they can be carried in some convenient manner, such as by the operator (in pouches or pockets in a vest, jacket, belt, harness, or comparable device that can be secured to the operator's shoulders, torso, and/or waist) or by an assistant or manager who works alongside or near the operator. This will reduce the weight and bulk of the detector arm, and will minimize operator fatigue.

Video display 70 can be comparable in size to a small hand-held video camera (“camcorder”), and it can be substantially lighter than a camcorder, since it will not need to be recording any video images. It and light source 84 can be powered by a battery, which can be part of the display unit 70, or which can alternately be a larger battery pack that can be carried in a vest, belt, harness, or other device worn by the operator.

In the embodiment shown in FIG. 1, gas hose 50 is affixed to the arm 18, by suitable means, such as slidable clips 54, or by tape, coated wire twists, adjustable plastic straps, etc. The inlet 52 of the hose 50 is positioned near the tip of arm 18.

In the embodiment shown in FIG. 1, four electronic components are also mounted near the tip of pole 18. Those components are a miniaturized video lens 82, a light source 82, a unidirectional microphone 84, and an omnidirectional microphone 86. Any such mountings preferably should be easily detachable devices, such as by using threaded connections, “quick connect” couplings, “bayonet” fittings, etc., so that a dirty, damaged, or malfunctioning device can be easily removed and cleaned or replaced.

In its retracted form, the detector arm should be short enough to allow it to be conveniently stored and protected during shipping; a retracted length of about 60 to about 120 cm (about 2 to 4 feet) is generally preferred. When fully extended, it generally should be at least about 2 to 3 meters (7 to 10 feet) long, and may extend up to about 6 meters (20 feet) long or even longer without becoming too unwieldy, so long as the operator can control its actual length during any stage of a rescue operation.

To make it properly extendable, the detector arm can be constructed using any suitable telescoping, segmented, or other extendable mechanism. Simple and inexpensive detector arms that can be manually extended can use mechanisms comparable to telescoping legs from camera tripods, or tent poles that use elastic cords inside segmented hollow tubes, or an even simpler system comprising hollow round segments with slightly angled conical dimensions, comparable to tubular extensions for a vacuum cleaner hose. More complex extendible mechanisms can use a small electric motor controlled by a switch mounted at or near the handle, to provide the operator with greater control and flexibility while crawling and climbing in cramped or hazardous conditions.

In one preferred embodiment, the complete detector arm assembly 10 can be hand-held, comparable to a conventional fishing pole. Alternately or additionally, the handle portion of the detector arm can be provided with belts, straps that use VELCRO™, or similar components that can allow the handle of the detector arm to be strapped or otherwise affixed to an operator's forearm. This can give the operator extensive control over the detector arm, while allowing one hand (or even both hands, if the tip of the rod can be momentarily rested on something) to remain free (or to be temporarily freed) for climbing, crawling, or similar activities.

If desired, the operator can carry or otherwise enable the use of two different video displays. For example, the holder can look at a small video display, such as an 8 to 10 cm (3 to 4 inches, measured diagonally) display screen, of the type used in small video cameras. This type of small, lightweight monitor can be coupled to the handle of the detector arm, held in the operator's hand, or mounted in a forearm holder which can be strapped to either of the operator's forearms. Alternately, the small monitor screen can be provided with a quickly reversible backing, such as VELCRO™. This will allow it to be affixed to and worn on an accommodating felt-like patch sewn onto the operator's sleeve, while also allowing the operator to remove it with one hand and inspect it closely, whenever necessary.

At the same time, an assistant or supervisor can be watching a second video monitor, which would be larger (such as about 40 to 80 cm (10 to 20 inches) or more, diagonally) and would show greater resolution and detail. If desired, the second video monitor can be carried by an assistant or supervisor who remains close to the operator, or it can rest on a small mobile platform at any nearby location (or a remote location, if suitable wiring or wireless transmission is provided). Alternately, if desired, a relatively large video monitor can be affixed in an easily reversible manner (such as by using a VELCRO-type mounting) on the back of a vest or jacket being worn by the person carrying the detector arm. This would allow anyone standing behind the operator to see, in detail, anything the video lens is being pointed at, while also allowing the video screen to be detached temporarily and held by an assistant or supervisor, if the person carrying the detector arm needs to crawl into a small or dangerous tunnel or other passageway.

If desired, the extendable mechanical arm can be provided with other devices as well, such as: (i) one or more joint devices which can allow the tip of the rod to be extended around a corner and/or inserted into non-linear tunnels and other irregular pathways; (ii) a rotatable pointing device which can allow the light source and video lens to be turned and pointed in any desired direction, under the control of the operator; and/or, (iii) a length indicator, on or near the handle, which tells the operator how far the detector arm is extended at any moment.

The entire assembly should be sufficiently light and mobile so that it can be carried and operated by one adult without assistance, preferably using only a single hand and arm, so that the other hand and arm will remain free for climbing, crawling, or other physical activity. The entire detector arm should be sufficiently lightweight so that it will not rapidly tire out a moderately strong adult who is in good physical condition.

In addition, the entire system preferably should be designed in a manner that allows the person carrying it to easily retract the arm and move any protruding or bulky components into a sheltered out-of-the-way position, in case he (or she) needs to focus his/her efforts and attention on crawling, climbing, or squeezing through a small tunnel or passageway inside a building, during a rescue or recovery operation.

For general purposes, the detector arm preferably should be provided with at least one microphone, which is coupled to a small speaker device 74. For maximum utility and flexibility, the system can be provided with both (i) an omnidirectional microphone, to detect the presence of any sounds indicating that one or more people are still alive inside a collapsed or damaged structure, and (ii) a direction-sensitive microphone (including a directional focusing device, if desired, such as a parabolic reflector bowl). Acting together, two such microphones can give an operator maximal flexibility in locating the direction and location of the source of any such sounds. If either type of microphone is used, it should be supported by a suitable amplifier, and at least one speaker 74 and/or a headphone device.

If desired, a third type of microphone can also be provided, which would be designed to be pressed against a solid structure (such as a concrete pillar or steel beam), to help detect tapping, settling, or similar noises that are travelling through the structural components of a building. This type of microphone, comparable to a seismic microphone, can provide useful information to a trained operator.

If desired, the system disclosed herein can also be provided with one or more transmitting and/or two-way communicating devices. Such devices can enable remote monitoring, in a safe location, of (i) the operator's exact location inside a collapsed or damaged structure, and (ii) the video images, gas concentrations, and other data that are being encountered, gathered, or otherwise detected by the sensor devices during a rescue or recovery mission.

In addition to any or all of the foregoing, any other type of electronic or other device can also be added to this system, to increase the set of useful detecting or analytical activities the system can perform inside a collapsed building or similar structure.

All necessary components for assembling this type of system are publicly available. A partial listing of such components, and their suppliers, is provided below. Most of this list of suppliers and model numbers was compiled during an Internet search, and this list is not complete; each type of component is available from other suppliers as well.

A miniaturized video lens, referred to as a “Lipstick Tube Bullet Camera” (model MVC6000 Bullet Cam) is available from Microvideo (http://www.microvideo.ca; phone 705-738-1755). Similar models called “SnakeCams” and “Helmet Cams” are also available.

Lightweight “palm-sized” video cameras, typically with extendible 3″ color display devices, are available from numerous suppliers (Sony, JVC, Canon, Panasonic, Sharp, etc.) at nearly any electronics store, in either digital or VHS-C formats. Nearly all of these allow the use of electronic cables using “RCA plugs” or similar plug devices to provide signal inputs; some also allow the use of fiber optic cables, S-VHS cables, or various computer-type cables as to convey a signal to a display monitor.

Omni-directional and direction-sensitive microphones, and miniaturized amplifiers and speaker systems designed for use with such microphones, are available from numerous suppliers, such as Sony, ElectroVoice, Shure, Radio Shack, etc.

Gas detectors with 1 ppm sensitivity, which can be assembled into a multi-gas detection system as described herein, are made by companies such as Crowcon Detection Instruments (Milford, Ohio), AIM Safe-Air (Austin, Tex.), and Marconi Applied Technologies (Elmsford, N.Y.).

Thus, there has been shown and described a new type of detector system for use in rescue and/or recovery operations inside a damaged structure. Although this invention has been exemplified for purposes of illustration and description by reference to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

1. An electromechanical assembly useful for locating survivors and corpses trapped in a damaged structure, comprising:
a. an extendible pole assembly which can be retracted when not in use, and which can be extended during use by a human operator, and having at least one handle segment and at least one tip segment;
b. means for reversibly affixing at least one video lens to the tip segment, during use, in a manner which establishes a known directional orientation of the video lens with respect to the handle segment;
c. means for reversibly affixing at least one light source to the tip segment during use;
d. means for reversibly affixing at least one microphone to the tip segment during use.

2. The electromechanical assembly of claim 1, which also comprises a gas inlet hose

3. The electromechanical assembly of claim 1, which also comprises a wiring harness.

4. The electromechanical assembly of claim 1, wherein the handle segment allows a gas detector device to be affixed thereto.

5. The electromechanical assembly of claim 1, wherein the handle segment allows a video display device to be affixed thereto.
